(19) United States
(12) Patent Application Publication
(10) Pub. No.: US 2007/0290089 A1
(43) Pub. Date: Dec. 20, 2007

(54) REEL AND REEL MANUFACTURING METHOD

(75) Inventor: Yasuhiro MORI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/754,572

(22) Filed: May 29, 2007

(30) Foreign Application Priority Data
Jun. 2, 2006 (JP) 2006-155130

(51) Int. Cl. G11B 23/107

(52) U.S. Cl. 242/348

(57) ABSTRACT

A reel includes a bottomed circular cylinder-shaped hub around which recording tape is wound, a first flange that is integrally disposed at an open side of the hub and holds one width direction end portion of the recording tape, a second flange that is disposed at a bottom wall side of the hub and holds the other width direction end portion of the recording tape, and a reel plate that is disposed at the second flange and is attracted by magnetic force to a rotating shaft of a drive device. An attachment portion disposed at, so as to project from, the bottom wall of the hub is inserted through through holes disposed in the second flange and the reel plate and caulked, whereby the second flange and the reel plate are attached to the hub.

### CROSS-REFERENCE TO RELATED APPLICATION

This application claims priority under 35 USC 119 from Japanese Patent Application No. 2006-155130, the disclosure of which is incorporated by reference herein.

### BACKGROUND OF THE INVENTION

1. Field of the Invention

The present invention relates to a reel around which is wound recording tape such as magnetic tape used for saving data of computers and the like.

2. Description of the Related Art

Conventionally, recording tape cartridges have been known where recording tape such as magnetic tape used as a data recording and playback medium (data backup) for computers and the like is wound onto a reel made of resin and the reel is housed by itself inside a case. There are instances where the reel of the recording tape cartridge is formed as a result of a lower flange and a hub being integrally molded and an annular upper flange being welded to the peripheral edge of the upper end of the hub (e.g., see JP-A No. 2001-135063) and instances where the reel is formed as a result of a hub including a bottom wall and an upper flange being integrally molded and an annular lower flange being welded to the peripheral edge of the bottom wall of the hub (e.g., see JP-A No. 2005-251272). A reel plate made of metal that is capable of being attracted by a magnet of a drive device is attached to the bottom wall of the reel (the hub).

In a reel where the lower flange and the hub are integrally molded, the number of man hours does not increase because the reel plate is attached to the bottom wall of the hub by insert molding. However, there is the problem that during molding, contraction or the like resulting from the cooling times of the resin material of the hub and the lower flange being different occurs, the lower flange becomes deformed, and the surface runout width of the lower flange increases. Further, there is also the potential for the upper flange that is welded to the hub to become deformed when the hub becomes deformed by the winding constriction of the recording tape. On the other hand, in a reel where the upper flange and the hub are integrally molded and the lower flange is welded to the hub, an increase in the surface runout width can be deterred in the upper and lower flanges. However, there is the problem that the number of man hours and the manufacturing cost increase because the reel plate is attached to the bottom wall of the hub after the lower flange is welded to the hub.

### SUMMARY OF THE INVENTION

Thus, in view of these problems, it is an object of the present invention to obtain a reel that can deter an increase in the surface runout width of the flanges and can prevent an increase in the number of man hours for attaching the reel plate.

In order to achieve this object, a first aspect of the invention provides a reel including: a bottomed circular cylinder-shaped hub around which recording tape is wound; a first flange that is integrally disposed at an open side of the hub and holds one width direction end portion of the recording tape; a second flange that is disposed at a bottom wall side of the hub and holds the other width direction end portion of the recording tape; a reel plate that is disposed on the second flange and is attracted by magnetic force to a rotating shaft of a drive device; and an attachment portion that is disposed at, so as to project from, the bottom wall of the hub and is inserted through through holes disposed in the second flange and the reel plate and caulked to attach the second flange and the reel plate to the hub.

According to the first aspect of the invention, the first flange disposed on the open side of the hub is molded integrally with the hub, and the second flange disposed on the bottom wall side of the hub is attached to the hub together with the reel plate, so an increase in the surface runout width of the first flange and the second flange can be deterred. Further, because it becomes possible to attach the second flange and the reel plate at one time (in one step), an increase in the number of man hours for attaching the reel plate can be prevented. Thus, the manufacturing efficiency of the reel can be improved.

In the reel of the first aspect of the invention, the attachment portion may be plurally disposed.

According to this configuration, the attachment strength of the second flange and the reel plate with respect to the hub can be improved.

In the first aspect of the invention, the attachment portions may be disposed at equidistant intervals.

According to this configuration, accurately centering and attaching the second flange and the reel plate with respect to the hub can be done easily.

In the first aspect of the invention, through holes through which a release projection disposed on the rotating shaft is inserted may be formed in the center of the bottom wall, the center of the second flange, and the center of the reel plate.

According to this configuration, even if the hub becomes deformed because of the winding constriction of the recording tape such that the center of the bottom wall swells due to the affect of the deformation of the hub, that deforming force can be allowed to escape because the through holes are formed in the centers thereof Thus, an increase in the surface runout width of the first flange and the second flange can be deterred.

In the reel of the first aspect of the invention, the attachment portion may be disposed in, so as to project from, the center of the bottom plate, and the through holes may be disposed in the center of the second flange and the center of the reel plate.

According to this configuration, the attachment strength of the second flange and the reel plate with respect to the hub can be improved, and accurately centering and attaching the second flange and the reel plate with respect to the hub can be done even more easily.

As described above, according to the present invention, there can be provided a reel that can deter an increase in the surface runout width of the flanges and can prevent an increase in the number of man hours for attaching the reel plate.

### BRIEF DESCRIPTION OF THE DRAWINGS

FIG. 1A is a schematic perspective view of a recording tape cartridge seen from above, and FIG. 1B is a schematic perspective view of the recording tape cartridge seen from below;

FIG. 2 is a schematic side sectional view showing a state before a drive gear meshes with a reel gear;

FIG. 3 is a schematic side sectional view showing a state after the drive gear meshes with the reel gear;

FIG. 4 is a schematic exploded perspective view of a reel;

FIG. 5 is a schematic perspective view of the reel;

FIG. 6 is a schematic exploded perspective view of another reel; and

FIG. 7 is a schematic perspective view of the other reel.

### DETAILED DESCRIPTION OF THE INVENTION

Best modes for implementing the present invention will be described in detail below on the basis of exemplary embodiments shown in the drawings. First, the schematic configuration of a recording tape cartridge 10 will be described, and then a reel 30 will be described. For the convenience of description, arrow A will represent the direction in which the recording tape cartridge 10 is loaded into a drive device and be referred to as a front direction (front side) of the recording tape cartridge 10. Arrow B will represent a direction orthogonal to the direction of arrow A and be referred to as a right direction (right side) of the recording tape cartridge 10. When the phrase “radial direction” is used below, this will indicate a direction parallel to a direction facing radially outward from an axial center (center) line of the reel 30 housed in a case 12.

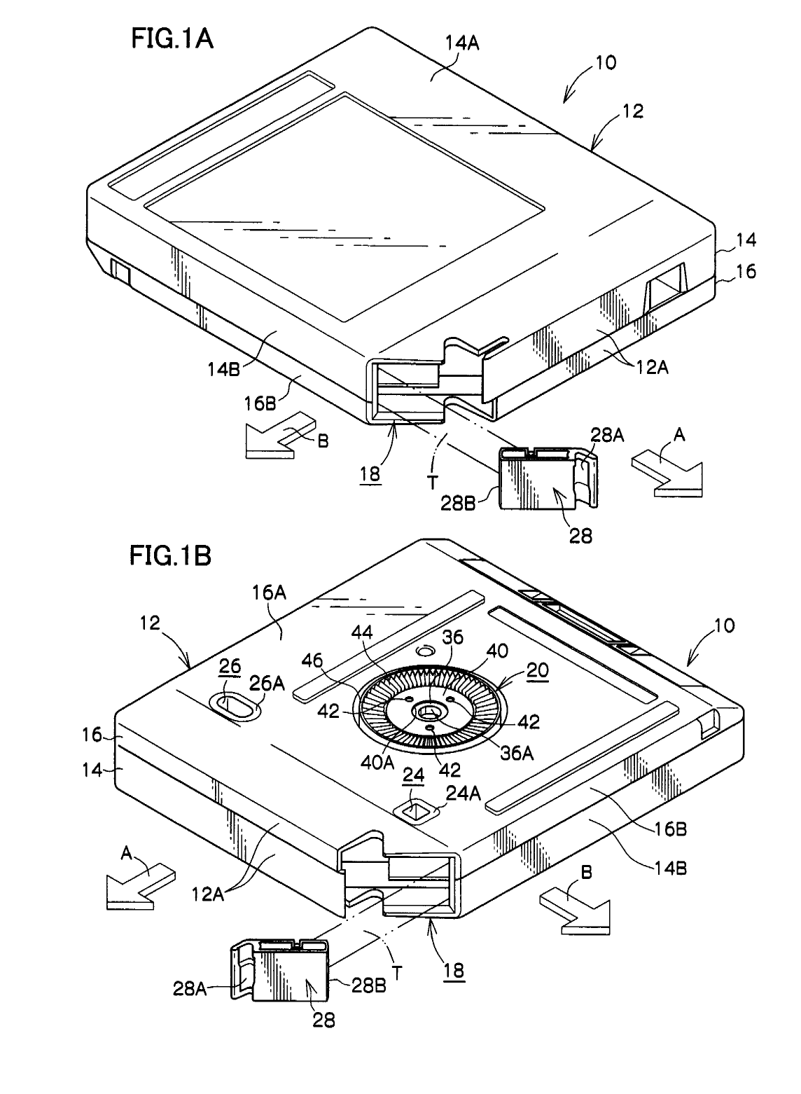

As shown in FIG. 1A to FIG. 3, the recording tape cartridge 10 is disposed with a case 12 made of resin. The case 12 is configured by joining together an upper case 14 and a lower case 16. Specifically, the upper case 14 is configured as a result of a substantially frame-like peripheral wall 14B being disposed upright along the outer edge of a top plate 14A that has a substantially rectangular shape when seen in plan view, and the lower case 16 is configured as a result of a substantially frame-like peripheral wall 16B being disposed upright along the outer edge of a bottom plate 16A having a shape substantially corresponding to the top plate 14A. The case 12 is formed in a substantially rectangular box-like shape when the upper case 14 and the lower case 16 are joined together by ultrasonic welding or with screws in a state where the open end of the peripheral wall 14B and the open end of the peripheral wall 16B have been brought into contact with each other.

An opening 18 that slants with respect to the loading direction is formed in the case 12 by cutting out corner portions of the top plate 14A, the peripheral wall 14B, the bottom plate 16A, and the peripheral wall 16B at the front side in the direction in which the recording tape cartridge 10 is loaded into the drive device. A circular gear opening 20 that penetrates the bottom plate 16A is disposed in the substantially center portion of the bottom plate 16A and serves to expose a later-described reel gear 44. An annular rib 22 is disposed on the edge portion of the gear opening 20 in the bottom plate 16A so as to project inside the case 12 and serves to prevent rattling of the later-described reel 30 and to prevent the ingress of dust.

A pair of positioning holes 24 and 26 is formed in the outer surface of the bottom plate 16A in the vicinity of the front end of the case 12. The two positioning holes 24 and 26 are disposed sac-like inside projecting portions (not shown) disposed upright inside the case 12 from the bottom plate 16A, and are arranged apart from each other on a hypothetical line in the direction of arrow B. The positioning hole 24 near the opening 18 has a substantially square shape when seen in bottom view that circumscribes a positioning pin (not shown) of the drive device, and the positioning hole 26 is an elongate hole that is long along the hypothetical line and has a width corresponding to the diameter of a positioning pin. Consequently, when the recording tape cartridge 10 (the case 12) is loaded into the drive device and the positioning pins are respectively inserted into the positioning holes 24 and 26, the recording tape cartridge 10 is positioned in the horizontal direction (left and right, front and back) inside the drive device.

Moreover, surfaces around the positioning holes 24 and 26 in the bottom plate 16A serve as reference surfaces 24A and 26A that are finished more smoothly than the other portion (design surface). The reference surfaces 24A and 26A are configured to contact reference surfaces (not shown) of the drive device disposed around the positioning pins when the positioning pins are inserted into the positioning holes 24 and 26. Thus, the recording tape cartridge 10 (the case 12) is positioned in the vertical direction inside the drive device.

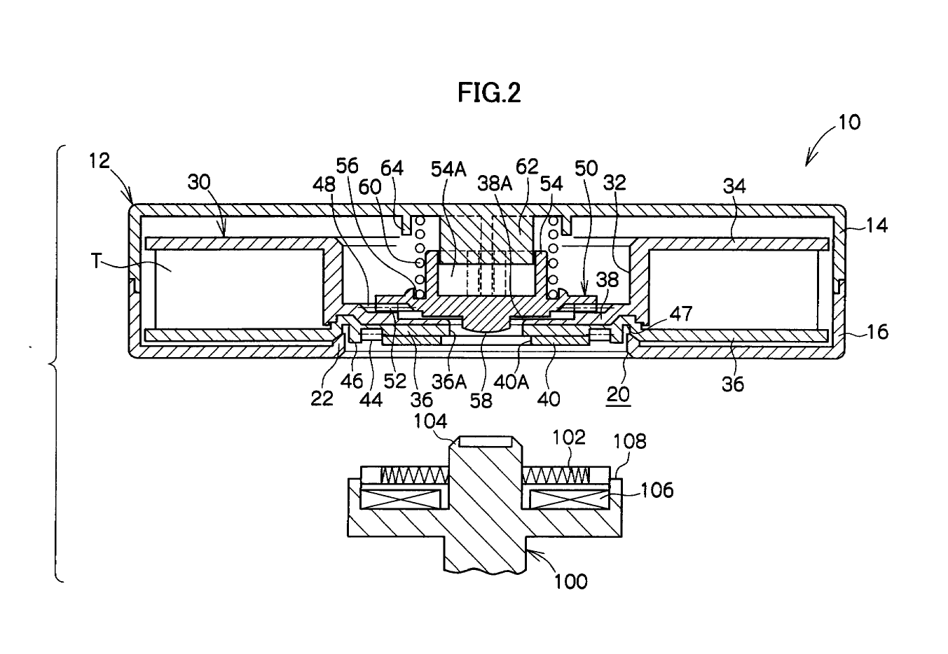

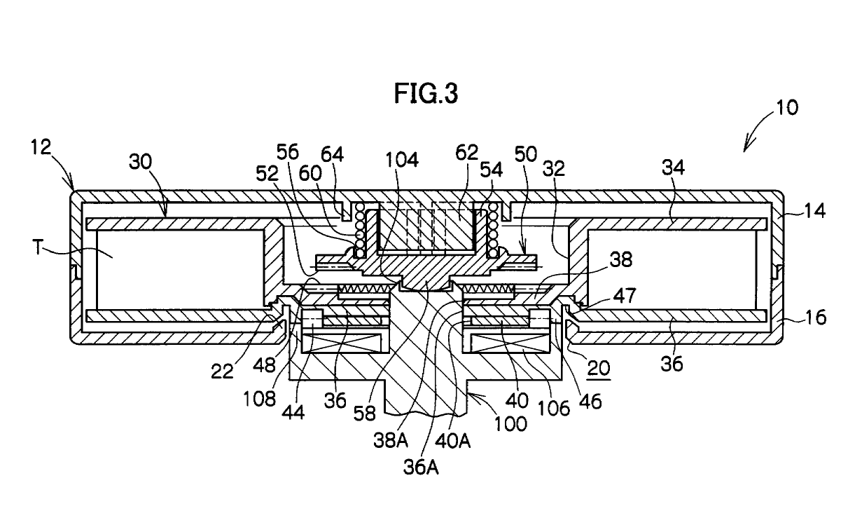

As shown in FIG. 2 and FIG. 3, just one reel 30 that will be described later is rotatably housed inside the case 12. Recording tape T such as magnetic tape serving as an information recording and playback medium is wound onto the reel 28 and, as shown in FIGS. 1A and 1B, a leader block 28 serving as a leader member is attached to the distal end of the recording tape T. The leader block 28 is housed and retained inside the opening 18 in the case 12 when the recording tape cartridge 10 is not in use. In this state, the leader block 28 closes the opening 18 and deters the ingress of dust and the like into the case 12.

An engagement concave portion 28A is formed in the distal end of the leader block 28, so that when the recording tape T is to be pulled out inside the drive device, the leader block 30 is extracted from the case 12 by a pullout member (not shown) that engages with the engagement concave portion 28A and is guided to a take-up reel (not shown) of the drive device. The end surface of the leader block 28 on the opposite side of the engagement concave portion 28A serves as a circularly arced surface 28B and is fitted into a reel hub (not shown) of the take-up reel to configure part of a take-up surface that takes up the recording tape T.

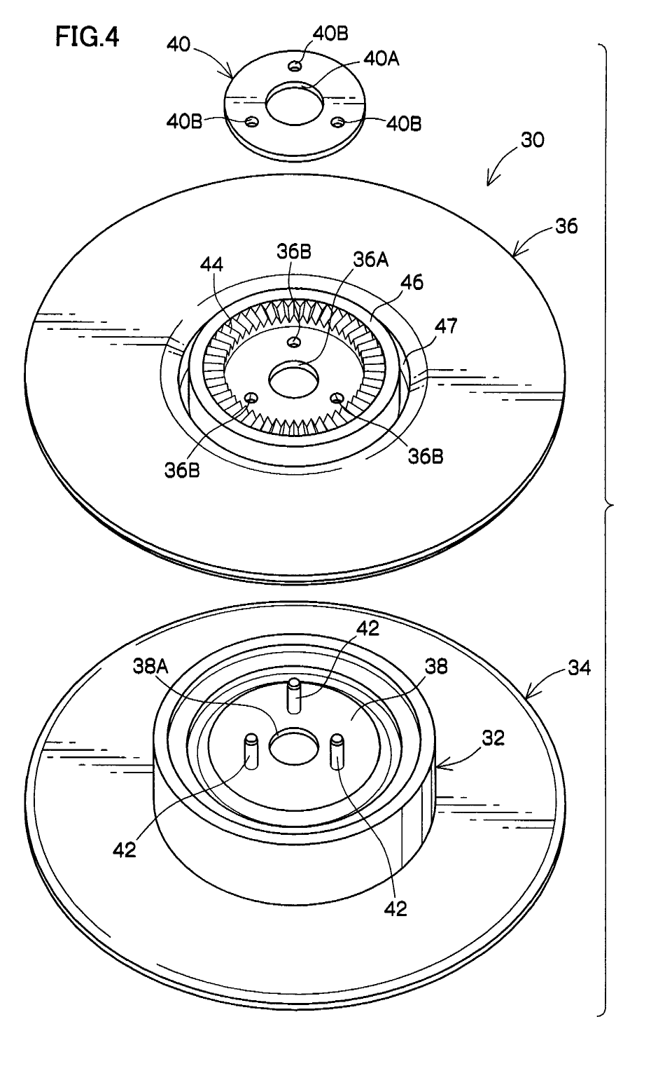

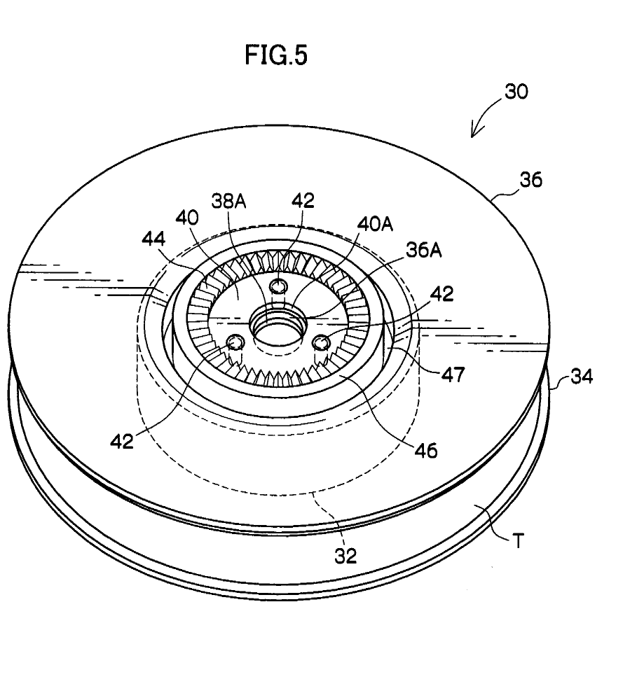

Next, the reel 30 and brake means that deters rotation of the reel 30 when the reel 30 is not in use (when the recording tape cartridge 10 is not loaded in the drive device) will be described. As shown in FIG. 4 and FIG. 5, the reel 30 is molded by a resin material and configured by a bottomed circular cylinder-shaped reel hub 32 that configures the axial center portion of the reel 30, an annular upper flange 34 that is integrally disposed on, so as to extend from, the peripheral edge portion of the open side of the reel hub 32, and a lower flange 36 that is attached to a bottom wall 38 of the reel hub 32. The upper flange 34 and the lower flange 36 are configured to hold the width direction end portions of the recording tape T that is wound around the outer peripheral surface of the reel hub 32.

A through hole 38A is disposed in the axial center portion (the center) of the bottom wall 38 of the reel hub 32, and a through hole 36A of substantially the same diameter as that of the through hole 38A is also disposed in the axial center portion (the center) of the lower flange 36. An annular reel gear 44 that is coaxial with the reel hub 32 when the lower flange 36 is joined together with the reel hub 32 is formed on the undersurface of the lower flange 36. The reel gear 44 is exposed from the circular gear opening 20 disposed in the substantial center of the lower case 16 as a result of the reel 30 being pressed against the lower case 16 by the biasing force of a later-described compression coil spring 60, is configured to be capable of meshing with a drive gear 102 disposed on a rotating shaft 100 of the drive device, and transmits rotational force to the reel 30.

An annular reel plate 40 is attached coaxially with the reel hub 32 and the reel gear 44 to the undersurface of the lower flange 36 further inward in the radial direction than the reel gear 44. The reel plate 40 is molded by a magnetic material, and a through hole 40A whose diameter is slightly (1 mm or less) larger than those of the through holes 36A and 38A is disposed in the axial center portion (the center) of the reel plate 40. Plural (e.g., three) through holes 40B are disposed in the reel plate 40 at equidistant intervals on a circle concentric with the reel plate 40, and plural (e.g., three) through holes 36B are also disposed in the lower flange 36 at equidistant intervals on a circle concentric with the lower flange 36. The through holes 36B and the through holes 40B are mutually communicated when the reel plate 40 is attached to the lower flange 36.

Plural (e.g., three) attachment-use bosses 42 are disposed so as to project to a predetermined height on the undersurface of the bottom wall 38 of the reel hub 32 at equidistant intervals on a circle concentric with the reel hub 32. The attachment-use bosses 42 are sequentially inserted through the through holes 36B and 40B, and the distal end portions of the attachment-use bosses 42 are caulked (crushed) by ultrasound waves generated by an unillustrated horn, whereby the reel plate 40 and the lower flange 36 are attached at one time (in one step) to the undersurface of the bottom wall 38.

A magnet 106 is annularly disposed in the rotating shaft 100 of the drive device between the drive gear 102 and a release projection 104 (described later). Consequently, the reel plate 40 is attracted by the magnetic force of the magnet 106 in a state where the drive gear 102 and the reel gear 44 are completely meshed. That is, axial shifting between the reel 30 and the rotating shaft 100 is prevented thereby, so that the meshed state between the reel gear 44 and the drive gear 102 is retainable.

An annular convex portion 46 serving as a height direction reference surface of the reel 30 inside the drive device is disposed on, so as to project from, the undersurface of the lower flange 36 on the outer peripheral portion of the reel gear 44. The reel 30 is positioned in the vertical direction as a result of a reference surface 108 disposed further toward the outer peripheral side of the rotating shaft 100 than the drive gear 102 contacting the annular convex portion 46. It will be noted that the reference surface of the reel 30 is not limited to the annular convex portion 46 that is shown and may also be configured by a convex portion disposed so as to project intermittently. An annular concave portion 47 into which the annular rib 22 is insertable is formed on the outer peripheral side of the annular convex portion 46.

Moreover, an annular engagement gear 48 coaxial with the reel hub 32 is formed on the upper surface of the bottom wall 38 of the reel hub 32, and a brake gear 52 of a brake member 50 serving as brake means that deters rotation of the reel 30 when the reel 30 is not in use is configured to be capable of meshing with the engagement gear 48. The brake member 50 is formed in a substantially discoid shape housed inside the reel hub 32 so as to be movable in the vertical direction (the axial line direction of the reel 30), and the brake gear 52 is annularly disposed on the outer peripheral portion of the undersurface of the brake member 50. An engagement wall portion 54 including a groove portion 54A that is substantially cross-shaped when seen in plan view is disposed upright on the upper surface of the brake member 50.

A rotation regulating rib 62 that is substantially cross-shaped when seen in plan view is disposed on, so as to extend from, the center of the inner surface of the top plate 14A of the upper case 14. Rotation of the brake member 50 with respect to the case 12 is deterred as a result of the rotation regulating rib 62 being inserted into the groove portion 54A in the engagement wall portion 54. That is, the brake member 50 is configured such that it can deter inadvertent rotation of the reel 30 when the reel 30 is not in use as a result of the biasing force of the later-described compression coil spring 60 causing the brake gear 52 to mesh with the engagement gear 48 of the reel hub 32. It will be noted that because the reel 30 is also biased downward by this biasing force, the annular rib 22 is inserted into the annular concave portion 47 such that movement (rattling) of the reel 30 in the radial direction is regulated, and the ingress of dust and the like from there is prevented.

An annular groove portion 56 is disposed in the brake member 50 on the outer side of the engagement wall portion 54. An annular projection 64 is disposed on the outer side of the rotation regulating rib 62 so as to project from the upper case 14. The compression coil spring 60 serving as a biasing member is held between the inner surface of the top plate 14A on the inner side of the annular projection 64 and the annular groove portion 56. That is, the compression coil spring 60 is disposed between the brake member 50 and the upper case 14 such that it does not shift position in the radial direction.

A substantially circular column-shaped operation projection 58 capable of being inserted through the through holes 38A and 36A is disposed in, so as to project from, the center of the undersurface of the brake member 50. The operation projection 58 is configured to be capable of contacting the release projection 104 disposed on, so as to project from, the axial center portion of the rotating shaft 100 of the drive device. That is, when the recording tape cartridge 10 is in use (when it is loaded in the drive device), the release projection 104 is inserted through the through holes 40A, 36A, and 38A, contacts the operation projection 58, and pushes the brake member 50 upward counter to the biasing force of the compression coil spring 60. Thus, the meshing between the brake gear 52 and the engagement gear 48 is released and, at the same time, the reel gear 44 and the drive gear 102 mesh with each other, so that when the rotating shaft 100 rotates about its axial center, the reel 30 becomes rotatable inside the case integrally therewith.

It will be noted that the rotation regulating rib 62 is configured such that the state where it has entered the groove portion 54A is maintained across the entire moving stroke of the brake member 50 in the vertical direction, so that the rotation regulating rib 62 also fulfills the function of guiding the movement of the brake member 50 such that the brake member 50 can move up and down without slanting. Further, although the through hole 40A in the reel plate 40 that is shown has a diameter that is slightly (1 mm or less) larger than those of the through holes 38A and 36A, it may also be formed in substantially the same diameter as those of the through holes 38A and 36A. However, when the through hole 40A in the reel plate 40 has a diameter that is larger than those of the through holes 38A and 36A, a situation where the release projection 104 of the drive device interferes with the reel plate 40 can be reliably avoided, which is preferable.

Next, the action of the recording tape cartridge 10 and the reel 30 of the above-described configuration will be described. When the recording tape cartridge 10 is not in use (during storage or transport when it is not loaded in the drive device), the opening 18 is closed by the leader block 28. Additionally, the brake member 50 is biased downward by the biasing force of the compression coil spring 60 to cause the brake gear 52 to mesh with the engagement gear 48. That is, inadvertent rotation of the reel 30 is deterred by the brake member 50.

When the recording tape cartridge 10 is to be used, it is loaded from the front wall 12A into the drive device along the direction of arrow A. When the recording tape cartridge 10 is loaded (inserted) into the drive device, the recording tape cartridge 10 is lowered a predetermined height, or the positioning pins rise upward and are respectively inserted into the positioning holes 24 and 26, and the reference surfaces of the drive device come into contact with the reference surfaces 24A and 26A. Thus, the case 12 of the recording tape cartridge 10 is accurately positioned in the horizontal direction and the vertical direction inside the drive device.

Further, at this time, the reel gear 44 does not project from the outer surface (undersurface) of the bottom plate 16A but is exposed to the outside of the case 12 from the gear opening 20, and the through holes 36A and 38A are exposed to the gear opening 20 through the through hole 40A in the reel plate 40. Consequently, when the rotating shaft 100 enters from the gear opening 20, the release projection 104 is inserted into the through holes 40A, 36A, and 38A. Then, the release projection 104 pushes the operation projection 58 upward so that the meshing between the engagement gear 48 and the brake gear 52 is released.

Moreover, at this time, the reference surface 108 of the rotating shaft 100 comes into contact with the annular convex portion 46, whereby the reel 30 is accurately positioned in the vertical direction. Then, the drive gear 102 meshes with the reel gear 44 in this state and the reel plate 40 is attracted to the magnet 106. Thus, the reel 30 rises a predetermined height inside the case 12 and becomes rotatable in a state where it does not contact the inner surface of the case 12.

Meanwhile, the pullout member of the drive device engages with the engagement concave portion 28A in the leader block 28 and pulls out the leader block 28 from the case 12. At this time, because the recording tape cartridge 10 (the case 12) and the reel 30 are accurately positioned inside the drive device, the pullout member can reliably engage with the engagement concave portion 28A in the leader block 28. In this manner, the leader block 28 that has been pulled out from the recording tape cartridge 10 is housed in a fitting portion (not shown) formed in the reel hub of the take-up reel of the drive device.

When the leader block 28 is housed in the fitting portion of the take-up reel and the circularly arced surface 28B configures part of the take-up surface that takes up the recording tape T, the reel 30 and the take-up reel are driven to rotate synchronously by the rotating shaft 100. Thus, the recording tape T is pulled out from the inside of the case 12 through the opening 18 while being taken up on the take-up reel, and a recording and playback head (not shown) disposed along a predetermined tape path records data to the recording tape T or plays back data recorded on the recording tape T.

When the recording of data to the recording tape T or the playback of data recording on the recording tape T ends and the recording tape cartridge 10 is to be ejected from the drive device, first, the recording tape T is rewound onto the reel 30 and the leader block 28 closes the opening 18. Then, the recording tape cartridge 10 moves upward or the rotating shaft 100 moves downward, whereby the magnet 106 moves away from the reel plate 40, the release projection 104 is removed from the insides of the through holes 38A, 36A, and 40A, and the meshing between the drive gear 102 and the reel gear 44 is released.

At this time, because the brake member 50 is biased downward by the compression coil spring 60, the brake member 50 moves to its downward position in accompaniment with the release projection 104 escaping from the insides of the through holes 38A, 36A, and 40A, and the brake gear 52 meshes with the engagement gear 48. Thus, the reel 30 again becomes locked such that inadvertent rotation thereof is deterred. Then, the recording tape cartridge 10 placed in this state is moved in the opposite direction of arrow A and ejected from the inside of the drive device by an unillustrated ejecting mechanism.

Here, in the reel 30, the upper flange 34 and the reel hub 32 are integrally molded, and the attachment-use bosses 42 disposed so as to project from the bottom wall 38 of the reel hub 32 are inserted through the through holes 36B and 40B disposed in the lower flange 36 and the reel plate 40 and caulked, whereby the lower flange 36 and the reel plate 40 are attached to the reel hub 32 at one time (in one step). Consequently, the number of man hours can be reduced in comparison to a conventional reel where the reel plate 40 is attached to the bottom wall 38 of the reel hub 32 after the lower flange 36 has been welded to the reel hub 32, and there is also not the drawback of the number of man hours increasing in comparison to a conventional reel where the reel plate 40 is fixedly attached to the lower flange 36 (the bottom wall 38 of the reel hub 32) by insert molding. Thus, the manufacturing efficiency of the reel 30 can be improved.

Further, because the reel 30 has a configuration where the upper flange 34 and the reel hub 32 are integrally molded and the lower flange 36 is attached to the reel hub 32 together with the reel plate 40 (the lower flange 36 is not molded integrally with the reel hub 32), an increase in the surface runout width of the upper flange 34 and the lower flange 36 can be deterred. Moreover, the through holes 38A, 36A, and 40A are disposed in the axial center portion (the center) of the reel hub 32, so that even if the reel hub 32 becomes deformed by the winding constriction of the recording tape T such that the axial center portion (the center) of the bottom wall 38 swells downward because of the affect of the deformation of the reel hub 32, that deforming force can be allowed to escape. Consequently, the surface runout width of the upper flange 34 and the lower flange 36 (deformation where the flanges contact the end portions of the recording tape T) can be reduced.

Further, because the plural (three in the drawings) attachment-use bosses 42 disposed on, so as to project from, the bottom wall 38 of the reel hub 32 at equidistant intervals on a circle concentric with the reel hub 32 are inserted through the plural (three in the drawings) through holes 36B and 40B disposed in the lower flange 36 and the reel plate 40 at equidistant intervals on circles concentric with the lower flange 36 and the reel plate 40 and attached, centering of the lower flange 36 and the reel plate 40 with respect to the reel hub 32 can be done accurately and easily. Moreover, because pluralities (three each in the drawings) of the attachment-use bosses 42 and the through holes 36B and 40B are formed, the attachment strength of the lower flange 36 and the reel plate 40 with respect to the reel hub 32 can be improved.

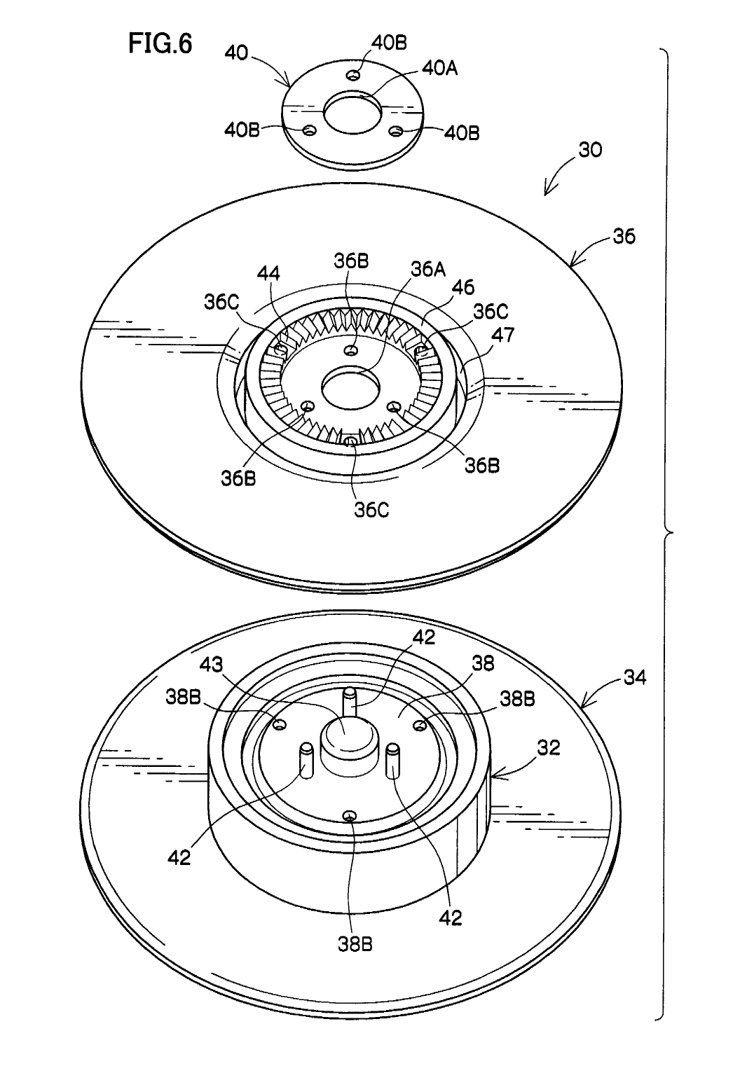

Next, another exemplary embodiment of the reel 30 will be described. It will be noted that the same reference numerals will be added to portions that are the same as those of the preceding exemplary embodiment and that detailed description thereof (including action and effects) will be omitted. As shown in FIG. 6, an attachment-use boss 43 whose diameter is larger (substantially the same as that of the through hole 36A) than that of the attachment-use bosses 42 is disposed in the axial center portion (the center) of the bottom wall 38 of the reel hub 32 so as to project to a predetermined height. Additionally, plural (e.g., three) through holes 38B, through which leg portions of an unillustrated release member for pushing up the brake member 50 are inserted, are disposed at predetermined positions in the bottom plate 38. Further, through holes 36C for allowing the leg portions to be inserted therethrough and project a predetermined height from the undersurface of the lower flange 36 are disposed in the reel gear 44 formed in the lower flange 36.

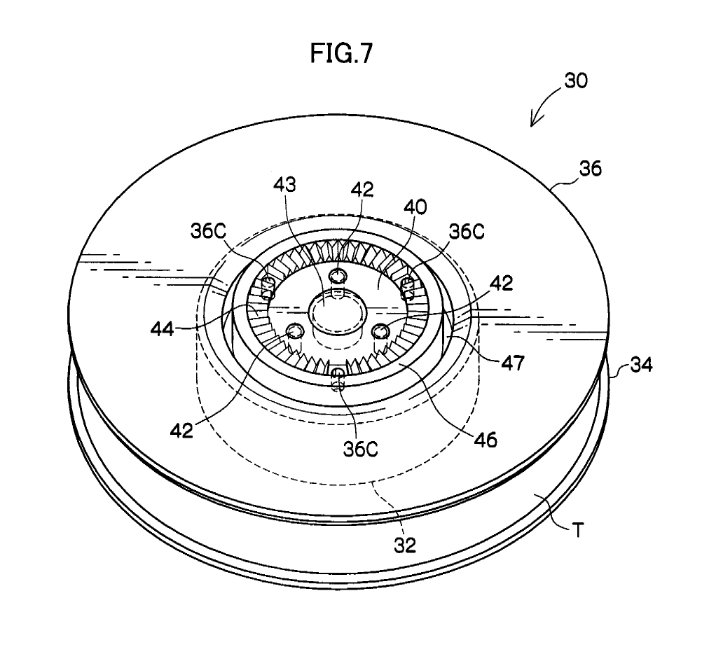

In the reel 30 of this configuration, the rotating shaft 100 of the drive device pushes up the leg portions (release member) projecting from the reel gear 44 and pushes up the brake member 50 by operation where the drive gear 102 meshes with the reel gear 44, so that the through hole 38A becomes unnecessary in the axial center portion (the center) of the bottom wall 38 of the reel hub 32. Consequently, it becomes possible to dispose the attachment-use boss 43 in, so as to project from, the axial center portion (the center) of the bottom wall 38. That is, as shown in FIG. 7, when the reel plate 40 and the lower flange 36 are attached at one time (in one step) to the bottom wall 38 of the reel hub 32, it becomes possible to attach them not only with the attachment-use bosses 42 but also with the attachment-use boss 43.

Thus, the attachment strength of the lower flange 36 and the reel plate 40 with respect to the reel hub 32 can be improved even more. Further, because the attachment-use boss 43 is disposed in the rotational center of the reel 30, centering of the lower flange 36 and the reel plate 40 with respect to the reel hub 32 can be done even more accurately and easily. It will be noted that although the attachment-use boss 43 and the attachment-use bosses 42 are disposed in the reel 30 shown in FIG. 6 and FIG. 7, the lower flange 36 and the reel plate 40 may also be attached just with the attachment-use boss 43 as long as attachment strength can be ensured. Further, when the attachment-use bosses 42 are disposed, the number thereof is not limited to the three that are shown.

The recording tape cartridge 10 of the preceding exemplary embodiments has a configuration including the leader block 28 as the leader member, but the recording tape cartridge 10 is not limited to the preceding exemplary embodiments. For example, the recording tape cartridge 10 may also have a configuration including a leader pin (not shown) or leader tape (not shown) as the leader member, or may have a configuration including a shielding member (such as an unillustrated sliding door that moves along a predetermined straight line or circular arc) that opens and closes the opening 18. Moreover, it suffices as long as the recording tape T is understood to be an elongate, tape-like information recording and playback medium capable of recording information and playing back recorded information. It goes without saying that the recording tape cartridge 10 (the reel 30) is applicable to recording tape T of all recording and playback formats.

What is claimed is:

1. A reel comprising:
a bottomed circular cylinder-shaped hub around which recording tape is wound;
a first flange that is integrally disposed at an open side of the hub and holds one width direction end portion of the recording tape;
a second flange that is disposed at a bottom wall side of the hub and holds the other width direction end portion of the recording tape;
a reel plate that is disposed on the second flange and is attracted by magnetic force to a rotating shaft of a drive device; and
an attachment portion that is disposed at, so as to project from, the bottom wall of the hub and is inserted through through holes disposed in the second flange and the reel plate and caulked to attach the second flange and the reel plate to the hub.

2. The reel of claim 1, wherein the attachment portion is plurally disposed.

3. The reel of claim 2, wherein the attachment portions are disposed at equidistant intervals.

4. The reel of claim 1, wherein through holes through which a release projection disposed on the rotating shaft is inserted are formed at the center of the bottom wall, the center of the second flange, and the center of the reel plate.

5. The reel of claim 1, wherein the attachment portion is disposed at, so as to project from, the center of the bottom plate, and the through holes are disposed at the center of the second flange and the center of the reel plate.

6. A reel comprising:
a bottomed circular cylinder-shaped hub around which recording tape is wound;
a first flange that is integrally disposed at an open side of the hub and holds one width direction end portion of the recording tape;
a second flange that is disposed at a bottom wall side of the hub and holds the other width direction end portion of the recording tape; and
an attachment portion that is disposed at, so as to project from, the bottom wall of the hub and is inserted through a through hole disposed in the second flange and caulked to attach the second flange to the hub.

7. The reel of claim 6, further comprising a reel plate that comprises a magnetic material and has a substantially discoid shape, wherein a through hole that allows the attachment portion to be inserted therethrough is formed in the reel plate, and the reel plate is disposed on the second flange.

8. The reel of claim 6, wherein the attachment portion is plurally disposed at equidistant intervals on the same circle.

9. The reel of claim 6, wherein through holes through which a release projection disposed on a rotating shaft of a drive device is inserted are formed at the centers of the bottom wall, the second flange, and the reel plate.

10. The reel of claim 7, wherein the attachment portion is disposed at, so as to project from, the center of the bottom wall, and the through hole is disposed at the centers of the second flange and the reel plate.

11. A reel manufacturing method comprising:
providing a first flange for holding one width direction end portion of recording tape, with the first flange including a bottomed circular cylinder-shaped hub around which the recording tape is wound and being integrally formed at an open side of the hub, and with the hub including an attachment portion disposed at, so as to project from, a bottom wall;
providing, at the bottom wall side of the hub, a second flange for holding the other width direction end portion of the recording tape, with a through hole being disposed in the second flange;
inserting the attachment portion through the through hole; and
caulking the attachment portion such that the second flange is thereby fixed to the hub.

12. The reel manufacturing method of claim 11, wherein the second flange is provided with a reel plate that comprises a magnetic material and has a substantially discoid shape, and wherein a through hole is formed in the reel plate and the attachment portion penetrates the through hole in the reel plate.

13. The reel manufacturing method of claim 11, wherein the attachment portion is plurally disposed at equidistant intervals on the same circle.

14. The reel manufacturing method of claim 12, wherein through holes through which a release projection disposed on a rotating shaft of a drive device is inserted are formed at the centers of the bottom wall, the second flange, and the reel plate.

15. The reel manufacturing method of claim 12, wherein the attachment portion is disposed at, so as to project from, the center of the bottom wall, and the through hole is disposed at the centers of the second flange and the reel plate.
